(19) United States
(12) Patent Application Publication
(10) Pub. No.: US 2004/0244003 A1
(43) Pub. Date: Dec. 2, 2004

(54) Apparatus and method for task scheduling for media processing

(75) Inventors: Joshua W. Perfetto, Santa Clara, CA (US); Xia Hong, San Jose, CA (US); Lalit Sarna, Mountain View, CA (US); Sorin Papuc, San Jose, CA (US)

Correspondence Address: SEED INTELLECTUAL PROPERTY LAW GROUP PLLC, 701 FIFTH AVE, SUITE 6300, SEATTLE, WA, 98104-7092, US

(73) Assignee: Vidiator Enterprises Inc., Nassau (BS)

(21) Appl. No.: 10/452,809

(22) Filed: May 30, 2003

(51) Int. Cl. G06F 9/46

(52) U.S. Cl. 718/100

(57) ABSTRACT

Techniques for sharing data between modules and techniques for implementing user-mode context switching are provided to produce a scheduling system that can be used for media transcoding, for example. An application is provided with control to modify its scheduling policy to take advantage of application-specific knowledge, which increases the data locality of scheduled tasks. Context switches are made during user mode and without having to switch to kernel mode.

### BACKGROUND OF THE INVENTION

1. Field of the Invention

The present disclosure relates generally to processor systems, and in particular but not exclusively, relates to intelligent task scheduling with information sharing in processor systems, utilizing user-mode context-switching techniques.

2. Description of the Related Art

As technical advances continue to multiply in today's society, there is an ever-increasing demand for processing capability that can support the technical advances. For instance, the Internet and other types of networks have provided users with virtually limitless access to many different kinds of content (such as audio and video streaming content), web pages, applications, and other resources. These resources are themselves increasing in complexity, in order to satisfy user demands for quantity and quality of services, such as use of dynamic content to replace static content on web pages. With the increased complexity of such resources, coupled with an astounding number of users attempting to access the resources, there is a corresponding requirement for extensive computation and other processing performed by processors.

To address these problems, some attempts have been made to optimize parallel or concurrent processing capabilities, so that a large number of tasks can be performed at the same time with minimal processing overhead per task. One such example is the Staged Event-Driven Architecture (SEDA) system disclosed in Welsh et al., “SEDA: An Architecture for Well-Conditioned, Scalable Internet Services,” in Proceedings of the Eighteenth Symposium on Operating Systems Principles (SOSP-18), Banff, Canada, October 2001; in Welsh, “An Architecture for Highly Concurrent, Well-Conditioned Internet Services,” Ph.D. Thesis, University of California, Berkeley, August 2002; and in Welsh, “The Staged Event-Driven Architecture for Highly Concurrent Server Applications,” Ph.D. Qualifying Examination Proposal, November 2000, all of which are incorporated herein in their entireties.

The SEDA system employs a user-mode event-based computing methodology, where a controller runs in user mode and works in conjunction with an application-supplied event handler. User mode refers to a privilege level where applications are allowed control over certain operations of a processor, whereas in a kernel mode, an operating system assumes a higher level of control over the processor. The event handler processes events that have been pulled from an incoming event queue. The controller, running on a small number of threads, performs scheduling and resource allocation for the event handler.

The event-based model of the SEDA system assumes that event-handling threads do not block. That is, rather than blocking execution along other threads when a particular thread encounters a data dependency (or other condition where that thread cannot continue for the time being), the state of that particular thread is stored explicitly and the other threads are allowed to proceed with execution by the event handler. When the data dependency is later satisfied, the task scheduler re-schedules the execution of that particular thread by the event handler. While this model may work satisfactorily in some situations, it is simply impractical to explicitly save a large number of states, which may be required with complex applications such as those involving media processing, for instance.

The SEDA system was created as an alternative to thread-based models, since SEDA systems use an event-based model that scales well. In the thread-based model, each incoming request or task is dispatched to a different thread, which processes the tasks and returns a result. Although relatively easy to program and well supported by modern languages and programming environments, the thread-based model does not scale well. Since a different thread is dedicated to each task and since there is a finite limit on the total number of threads, a thread-based system can be easily overwhelmed when the number of tasks greatly increases.

Moreover, with thread-based models or with synchronous-based models, the processor switches to the kernel mode when a blocking thread is encountered. The switch to the kernel mode allows the operating system to perform an operating system context switch (or “kernel mode context switch”), where the operating system initiates execution on other threads until the original blocking thread is able to resume. One disadvantage of this approach includes increased overhead associated with releasing application control of the processor to the operating system (e.g., switching from user mode the kernel mode). Another disadvantage is that the operating system does not have the intelligence to know data dependencies, and therefore cannot intelligently schedule or block thread execution in the most efficient manner.

While SEDA systems were created to address some of the drawbacks of thread-based models, the event-based model of SEDA systems can impose unnecessarily difficult constraints on the application writer, thereby greatly complicating construction of some types of applications. Also, many existing codes are already written for the thread-based or synchronous-based models, and therefore, it is not practical to integrate these codes into an event-based SEDA system.

### BRIEF SUMMARY OF THE INVENTION

One aspect of the invention provides a transcoder unit having at least one decoder and a plurality of encoders arranged in a hierarchal structure. Each of the encoders and decoders able to produce output data and to use input data. A data sharing component is linked to the transcoder unit to allow certain ones of the encoders and decoder to share common input data or common output data. A task scheduler is linked to the transcoder unit to schedule tasks to be performed by the encoders and decoders, determined at least in part based on shared common data. The task scheduler is further able to use user-mode context switching to allow a first task to yield execution to a second task and then allow the first task to subsequently resume execution while remaining in the user-mode.

### BRIEF DESCRIPTION OF THE SEVERAL VIEWS OF THE DRAWINGS

Non-limiting and non-exhaustive embodiments of the present invention are described with reference to the following figures, wherein like reference numerals refer to like parts throughout the various views unless otherwise specified.

FIG. 1 is a functional block diagram illustrating an example “uses” relationship between a data-sharing technique and a task-scheduling technique in accordance with an embodiment of the invention.

FIG. 2 illustrates an example architecture with which an embodiment of the invention may be implemented.

FIG. 3 is a flowchart illustrating an embodiment of the data-sharing technique.

FIG. 4 is a block diagram illustrating user-mode context switching in accordance with an embodiment of the invention.

FIGS. 5A and 5B are flowcharts illustrating operations associated with user-mode context switching in accordance with an embodiment of the invention.

### DETAILED DESCRIPTION

Embodiments of techniques to employ user-mode context switching in connection with intelligent task scheduling and data sharing are described herein. In the following description, numerous specific details are given to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As an overview, one embodiment of the invention combines some elements of SEDA (but without its exclusively event-based model), a technique for sharing data between modules, and a technique for implementing user-mode context switching to produce a scheduling system that is optimal for media transcoding, for example. Also, an embodiment provides an application with control to modify its scheduling policy to take advantage of application-specific knowledge, which increases the data locality of scheduled tasks. That is, if data is locally cached and can be shared by multiple tasks, much cache misses can be avoided if the tasks are scheduled in a manner that permits the tasks to use the data while the data is present in a cache or other storage location. In contrast to techniques that have reduced efficiency by implementing determination of cache locality in the operating system in the kernel mode, an embodiment of the invention allows for application-specific knowledge about data locality to be used by the task-scheduling algorithm, which operates in the user mode. Applications may have far greater knowledge of the data a thread or task will be accessing, and are therefore used in an embodiment of the invention to influence or control the scheduling of tasks.

The limitations of the event-based programming methodology used by SEDA, where all code in the system is written for the more complex event-based model, are eliminated. Rather, one embodiment of the invention eliminates the requirement that all tasks be event-based, and permits code written for the thread-based model to be run under a user-mode task scheduler, optionally in conjunction with event-based tasks.

One specific embodiment improves the efficiency and performance of multiple simultaneous media encodings by utilizing intelligent scheduling and sharing of information, while maintaining a synchronous programming methodology for stateful media compressors/decompressors (“codecs”). While such an embodiment may be provided in the context of media processing or streaming media implementations for purposes of illustration herein, it is appreciated that other embodiments of the invention may be implemented in environments that would benefit from application-controlled task scheduling and which do not necessarily involve media processing. Therefore, the invention is not limited solely to media processing.

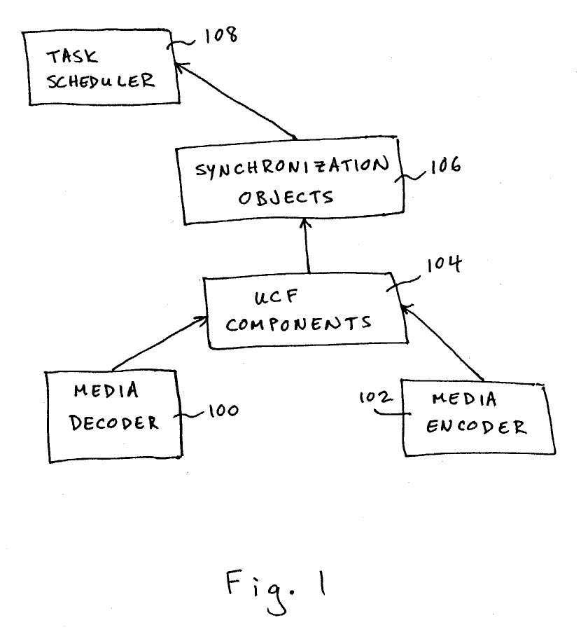

A data-sharing technique and a task-scheduling technique are provided by an embodiment of the invention. FIG. 1 is a functional block diagram illustrating an example relationship between these two techniques in accordance with an embodiment of the invention. In FIG. 1, the various arrows represent “uses” relationship of software systems, wherein the correctness of one component depends on the correctness of components it uses.

An embodiment of a media decoder 100 comprises a software decoder that receives a data stream (such as a data stream in MPEG-4 format) and decodes that data stream to another format. A software media encoder 102 encodes the data stream provided by the media decoder 100 (or provided from some other source) and produces an output therefrom. The media decoder 100 and media encoder 102 can comprise part of Universal Codec Framework (UCF) components 104, such as an architecture having codecs used in connection with a dynamic transcoder, as provided by Luxxon Corporation of San Jose, Calif. (now Vidiator Technology, Inc.). It is appreciated that the UCF components 104 merely provide a non-limiting illustrative example—other embodiments may be implemented based on non-UCF architectures. The UCF components 104 provide a data-sharing technique as will be described later below.

The UCF components 104 generate various data dependencies, execution states, and other information as its various internal components process data during transcoding sessions. Synchronization objects 106 provide function calls to a task scheduler 108 to instruct the task scheduler 108 to initiate user-mode context switches in one embodiment. The task scheduler 108, using the task-scheduling technique, can also control execution of various tasks within the UCF components 104.

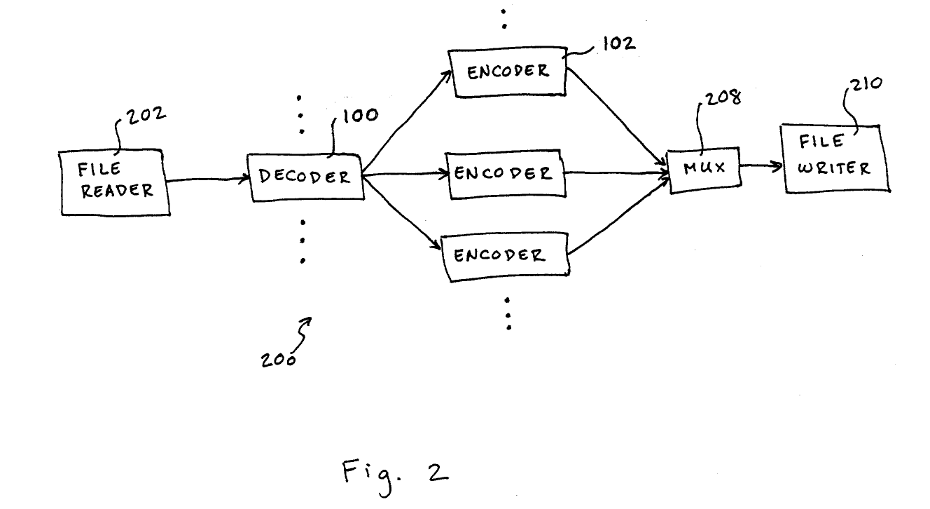

FIG. 2 illustrates an example UCF architecture 200 with which an embodiment of the invention may be implemented. The UCF architecture 200 encompasses the UCF components 104 of FIG. 1 (including the media decoder 100 and media encoder 102). In particular, the UCF architecture 200 includes a file reader 200 (or other data source) that provides data to be decoded by the decoder 100. The decoder 100 generates output data to other file readers 200, to other codecs in the same transcoding session, or to both. Decoders 100 can be assembled in hierarchical structures in which a base layer decoder has the output filtered by an upper layer decoder.

Encoders 102 encode data received from codecs in the same transcoding session and generate output data to the other components (such as to a multiplexer 208) or to other codecs (such as to other encoders 102) in the transcoding session. An output of the multiplexer 208 is provided to a file writer 210 or other component that can send the encoded data to its next destination.

In an embodiment, a transcoding session comprises one or more decoders 100 receiving related input data streams, and zero or more encoders 102 generating specific forms of data out of a subset of the data generated by the decoders 100 in the same transcoding session. Input data streams are related if they are part of a hierarchical layer structure or are alternative sources for the same destination (e.g., input to the multiplexer 208). Multiple transcoding sessions can be instantiated at the same time (symbolically represented in FIG. 2 by ellipsis around the decoder 100), and at least one decoder 100 is created before any encoder 102 can be created, since the encoder's 102 input is not exposed to the file reader 202.

Examples of systems having transcoder architectures with which an embodiment of the invention may be implemented are disclosed in U.S. Pat. No. 6,498,571, which claims priority to U.S. Provisional Patent Application Serial No. 60/169, filed Dec. 9,1999, both of which are assigned to the same assignee as the present application. U.S. Pat. No. 6,498,571 also references U.S. application Ser. No. 09/502,409, which further discloses a transcoding and/or decoding and encoding system. All of these patent documents are incorporated herein by reference in their entireties.

In one embodiment, the data sharing technique that is linked to and used by the UCF components 104 (and/or by the UCF architecture 200) comprises a component having “Brokers” and “Traders.” Each “trading session” (analogous to a transcoding session) comprises a single Broker (analogous to an application), which manages the trading of resources (such as data for or results of a task) between multiple traders. Traders (analogous to a decoder 100, an encoder 102, or other component in the UCF architecture 200) may be registered and unregistered with the Broker.

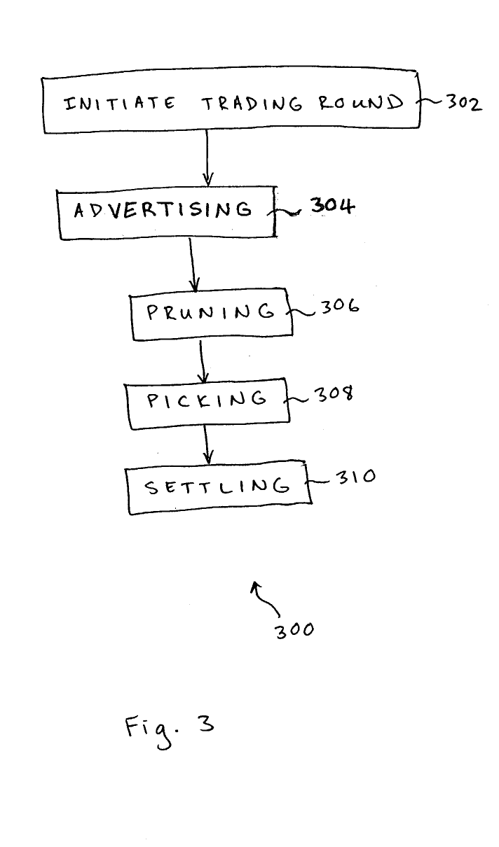

FIG. 3 is a flowchart 300 illustrating an embodiment of this data-sharing technique. Components of the flowchart 300 (or other flowcharts of diagrams shown and described herein) may be implemented in software or other machine-readable instruction stored on a machine-readable medium. A processor may execute such instructions.

When a Trader knows that it will generate a resource, that Trader notifies the Broker of this fact, so that the Broker may initiate an asynchronous trading round at a block 302, unless the resource has dependencies. For example, the decoder 100 might finish a decoding task, which results in generation of decoded output data as the available “resource.” During a trading round, all Traders have an opportunity to use the resources being traded, or to contribute additional related resources of its own. Thus, the encoders 102 are given an opportunity to claim the decoded output data of the decoder 100 for their use (if that decoded output data is appropriate for them), or to contribute their own encoded output data.

Once a trading round has begun (e.g., one Trader, the “source Trader”, has advertised a resource for trading to the Broker), the Broker calls all other such Traders (other than the source Trader), and notifies them of the resource that the source Trader presented for trading. Upon receiving such a notification, a Trader may chose to consume the advertised resource and modify it. The Trader advertises the modified resource by placing these resources in a trading “Bag.”

After all non-source Traders have been given the opportunity to offer their own resources for trading (referred to as “Advertising” in a block 304), all Traders are presented with the full Bag of offered resources from all other offering Traders, and given a chance to remove their offer, which they may do if a “better” offer is available, such as one judged to be “cheaper.” This is referred to as “Pruning” in a block 306, and can be likened to a situation where one of the encoders 102 chooses to use data from another encoder 102 instead of data from the decoder 100, if the other encoder's 102 data is more up to date or valid, for instance.

After all such offers have been pruned at the block 306, all Traders are asked to select from the Bag of available resources those which they would like to receive, and to notify the Broker of these resources. This is referred to as “Picking” in a block 308, and can be likened to an encoder's 102 selection of data to use for its processes, which is tracked by or otherwise made known to the application.

Finally, all Traders are given the opportunity to check if other Traders have selected their resources for trading, and to then take whatever actions are appropriate. This is referred to as “Settling” in a block 310.

The embodiment of FIG. 3 thus provides a technique where the data produced (or to be produced) can be determined, along with the component that will consume that data and the data dependencies. Such information can be ascertained by the application during the various negotiation and other processes described above, and can be provided to the task scheduler 108 by the application. With this information, the task scheduler 108 is able to intelligently schedule tasks.

For instance, consider a situation where the decoder 100 has generated decoded output data. At that point in time, 7 out of 10 encoders 102 can be run. However, out of the 7 encoders 102, only 3 of them are appropriate consumers of the decoded output data generated by the decoder 100. In this situation, the 3 encoders 102 “pick” that output data at the block 308. The task scheduler 108 (under control of the application) then schedules these 3 encoders 102 to execute their tasks using that output data and while that output data is currently available in the cache (or data register or other data repository). This increases the number of memory cache hits during the execution, thus improving performance.

Accordingly in the above example, an embodiment provides a method for sharing data between data producer elements and consumers (such as media codecs or other data user element), where there is a one-to-many relationship between producers and consumers. Data producers and data consumers can also be easily associated together. Moreover, an embodiment provides a method for sharing data between consumers of the same data source, where such consumers may perform some similar processing, but through the utilization of data sharing, only one such consumer need perform such processing and can provide its results to the other consumers. In implementations that do not use an embodiment of this data-sharing technique, a single decoder would feed raw media data into a series of encoders, all of which perform at least some similar processing, and would result in an amount of redundant computation, thereby decreasing performance.

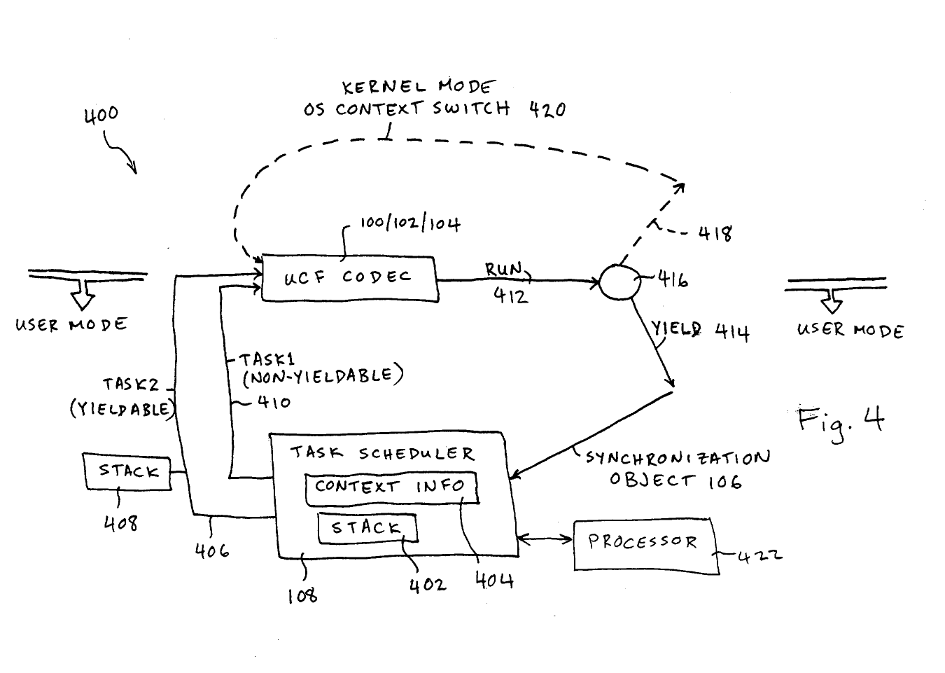

FIG. 4 is a block diagram 400 illustrating user-mode context switching in accordance with an embodiment of the invention. One or more processors 422, such as central processing units (CPUs), execute at least some of the various processes described hereinafter. A UCF codec 100/102/104 corresponding to the similarly referenced components of FIG. 1 is shown. As a result of the data-sharing technique described above, the application is able to manage and control the scheduling of tasks by the task scheduler 108, which is operating under user mode (represented by a double-lined section arrow symbol in FIG. 4). The task scheduler 108 can schedule and run tasks based on the data producer, data consumer, and data dependency information that the application obtained using the data sharing technique or based on the application's application-specific knowledge.

The task scheduler 108 in one embodiment is a thread that keeps track of the various tasks being executed. The task scheduler 108 stores context information 404 (e.g., stack position, register states, reason for yielding, etc.) about each particular task in task scheduler data structures and in yieldable task's stack 408. The task scheduler 108 may schedule either or both non-yieldable tasks 410 or yieldable tasks 406 that are applicable to the UCF codecs 100/102/104.

A task normally comprises stateful data as well as a function to run the task (such as a “Run function” 412). Each time a task is executed, the task scheduler 108 calls the Run function 412, which does a certain amount of work, and returns. As a prerequisite in an embodiment, tasks should not block the operating system (OS) thread on which their Run function is called, so that the task scheduler 108 (and not the OS) remains in control of the processor 422. In this manner, kernel-mode context switch handled by the OS is prevented—the processor 422 stays in user mode and any context switches are performed in user mode by the application task scheduler 108.

The user-mode context switching technique of one embodiment extends the concept of a task to a “yieldable task.” An embodiment of the yieldable task 406 is a task, which in additional to the Run function and stateful data, also has a stack 408 (as a thread would have a stack in a thread-based model). The yieldable task is able to voluntarily give control of the processor 422 back to the task scheduler 108 without returning from its Run function. When the yieldable task gives up control (“yields” at 414, such as if a data dependency is encountered at 416 during execution), a user-mode context switch is performed by waiting on a synchronization object 106 that instructs the task scheduler 108 to perform the context switch. Also, context information (e.g., relevant register states) of that yieldable task 406 is pushed onto its stack 408. The processor 422 is then loaded with the context information 404 and stack position 402 of the task scheduler 108, which subsequently selects the next task to be run by the processor 422. Once the condition that caused the yielding (e.g., a data dependency) of the yieldable task 406 has been satisfied, then the yieldable task 406 resumes where it had previously ended, with the processor 422 using the information in its stack 408 to determine where to continue execution.

In an embodiment, a programmer determines yieldable tasks 406 in advance. An example of a non-yieldable task is a task that is capable of maintaining the states in its own (e.g., designed with an explicit finite state machine), while a yieldable task is a task that does not maintain its own state and may rely on external mechanism(s) to store the states between context switches. One such external mechanism is the call stack, maintained automatically by modern programming languages. In addition to containing the specific CPU context information during a yield, the call stack contains function calls, argument values, and local variables, all of which represent task state. Since additional overhead is associated with yieldable tasks (e.g., extra memory for stack, and context switching overhead, etc.), efficiency dictates that as many tasks be designated as non-yieldable as possible.

This user-mode context switching is to be contrasted with OS context switching in the kernel mode. Broken lines in FIG. 4 depict such a kernel mode context switch. At 416, a function (such as a Wait function 418) is called due to a data dependency, for example. This Wait function 418 calls the OS (often via a trap) to perform an OS context switch 420 to another thread, which involves switching from user mode to kernel mode—this technique does not keep the mode in user mode as with an embodiment of the invention.

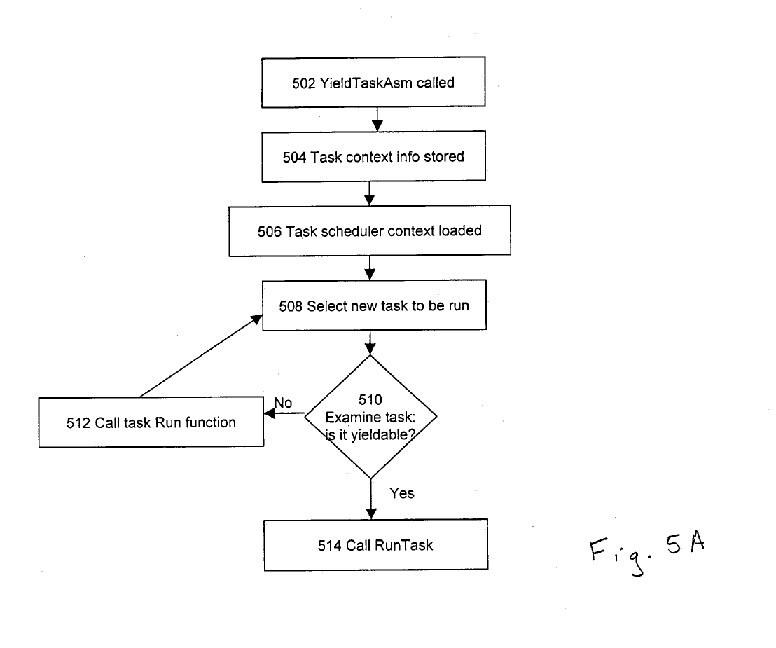

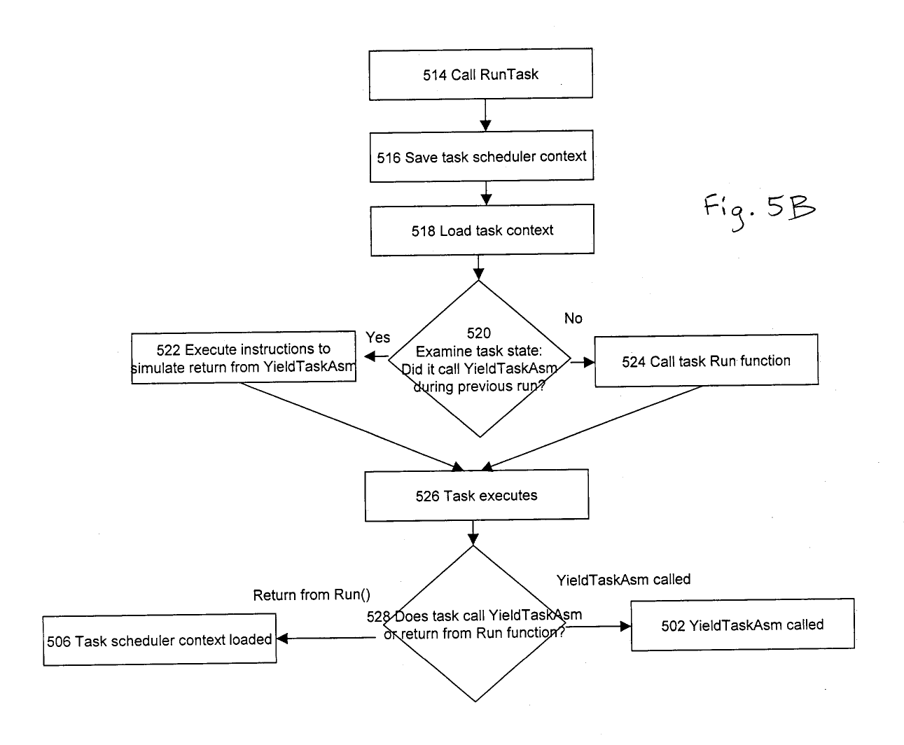

In one of the above-described examples of an embodiment of the invention, the user-mode context switching technique comprises two software functions: running the task (“RunTask”) and yielding (“YieldTaskAsm”). FIGS. 5A and 5B are flowcharts 500 illustrating these two components in further detail in accordance with an embodiment of the invention. FIG. 5A begins at a block 502, with a call to YieldTaskAsm (corresponding to a yieldable task 406 yielding), to demonstrate an embodiment of the user-mode context switching process

At a block 504, the task's context information 404, currently resident on the processor 422, is saved to the task scheduler 108 and to the yieldable task's stack 408. At a block 506, the scheduler stack 402 and scheduler context information (such as CPU registers and flags) are loaded into the processor 422. The task scheduler 108 then selects a new task to run at a block 508, according to the scheduling policy and other application-specific information (such as data dependencies) available to it.

At a block 510, the task to be run is examined to determine if it is a yieldable task or a non-yieldable task. Yieldable and non-yieldable task can be differentiated in an embodiment by checking a Boolean flag in the task object itself, which is set when the task is created as yieldable. If the task is determined to be non-yieldable, the task's Run function 412 is called at a block 512. Upon the non-yieldable task's Run function returning, flow continues at the block 508, with the task scheduler 108 selecting a new task to run. If at the block 510 the task is determined to be a yieldable task, then RunTask function is called at a block 514.

With reference now to FIG. 5B, flow then continues to a block 516, where the task scheduler's 108 CPU context information is saved from the processor 422 to the task scheduler stack 402. At a block 518, the task context information 404 and yieldable task stack 408 is then loaded.

At a block 520, it is then determined if the task to be run ended its last execution by yielding—in other words, calling YieldTaskAsm. If it did, executions to simulate a return from YieldTaskAsm are executed in a block 522. If it did not, the task's Run function 412 is called at a block 524.

Regardless of the decision at the block 520, the processor 422 then executes the task. The task performs its work at a block 526. Eventually, the task's execution will cease as a result of one or two actions, illustrated in a block 528. If the yieldable task 406 returns from its Run function 412, flow continues at the block 506, with the task scheduler stack 402 being then loaded into the processor 422, along with corresponding task scheduler CPU state (saved on task scheduler stack 402). Flow then continues to the block 508 as described earlier.

If at block 528 the yieldable task 406 yields, by calling YieldTaskAsm. The YieldTaskAsm function can be called when a Wait on a synchronization object 106 is called. If the synchronization object 106 is not set, the task scheduler 108 knows that it has to perform a user-mode context switch to another task.

Flow then continues at the block 502, as described at the beginning of this flow case. The task scheduler 108 will examine the reason why the task is returned, and schedule the next task to run following the steps from the block 502 again. When a yielding task is ready to resume control (i.e., the condition it is waiting on is fulfilled), the task scheduler 108 will put the task back into the schedulable task pool, and based on the scheduling algorithm, the task will be scheduled accordingly.

Accordingly from the above-described embodiments that use a task scheduler to schedule tasks, rather than dedicating a thread for each task, scalability of applications is improved, meaning that the multitasking overhead is smaller than that which would be present under traditional OS-based multithreading models, as the number of tasks or threads increase. Existing code, which is written for a thread-based model, can benefit from the advantages of the user-mode task scheduler 108. For instance, without a user-mode context switching mechanism, code written for a thread-based model would still expect to block until a needed event (such as data becoming available) has occurred—it suffers additional processor cycles because of the extra overhead involved between user and kernel mode switching.

Moreover, new code, which would be difficult to write under the event-based model of SEDA systems, can be constructed under the easier-to-program environment of thread-based or synchronous-based models, thereby reducing development time, required developer skill, and the number of bugs introduced. As all code, including that written for the thread-based model, can be run under the user-mode task scheduler 108, difficulties of using a user-mode task scheduler in conjunction with traditional OS-based multitasking models can be reduced or eliminated.

In addition to the above-described embodiments, a more intelligent scheduling mechanism may be introduced to leverage the cache locality of each processor. For instance, a transcoder may use a set of related processes when executing media processing. Such a set comprises a decoder, several encoders, and several other related tasks. Data is sent from the decoder to the encoders, and also from one encoder to other encoders, such as per the UCF architecture 200 of FIG. 2. The application has knowledge of the data-flow graph between these tasks, and so can ensure related tasks are scheduled on processors such that, when a data-producing task is run on a certain processor, consumers of that same data are also run on the same processor, to the extent that this does not detract from system performance (i.e., there is a tradeoff between computational power and memory usage). Doing this advantageously increases the likelihood of such data being in the processor's memory cache while accessed by consuming tasks. See generally Anshus et al., “Thread Scheduling for Cache Locality,” in Proceedings of the Seventh International conference on Architectural Support for Programming Languages and Operating Systems, Cambridge, Mass. USA, 1996 for background information.

An enhancement of the above producer-consumer scheduling algorithm can be made by the scheduling of related tasks at specific times (i.e., run the data consumers shortly after the data producer completes its execution). The rationale for this is that, if other tasks run in the meantime, the memory accesses of such tasks will cause their own data to be read into the processor's cache, thereby a likelihood of displacing cached data that will be needed when the data consumer is finally run. Thus, by knowing the data relationships among tasks, the related tasks can be scheduled in time by the task scheduler 108 in a more optimal manner.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention and can be made without deviating from the spirit and scope of the invention.

For example, while embodiments have been described in the context of media processing systems, it is appreciated that the invention is not limited to this specific implementation. Other embodiments may be implemented in a system having a server where a large number of clients are simultaneously dealt with (e.g., web server, application server, business logic server, game server, and the like). Another example is data processing system, real-time or offline, where there is a one-to-one or one-to-many relationship between source and processed data (e.g., DSP systems, financial or other data analysis tools, and the like).

The functions RunTask and YieldTaskAsm were used as examples above. It is appreciated that these are merely illustrative labels and that functions may be termed differently in other embodiments.

These and other modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. An apparatus, comprising:
a transcoder unit having at least one decoder and a plurality of encoders arranged in a hierarchal structure, each of the encoders and decoders able to produce output data and to use input data;
a data sharing component linked to the transcoder unit to allow certain ones of the encoders and decoder to share common input data or common output data; and
a task scheduler linked to the transcoder unit to schedule tasks to be performed by the encoders and decoders, determined at least in part based on shared common data, the task scheduler further able to use user-mode context switching to allow a first task to yield execution to a second task and then allow the first task to subsequently resume execution while remaining in the user-mode.

2. The apparatus of claim 1, further comprising a stack associated with the first task, wherein state information is saved to the stack by a processor if the first task yields to the second task and wherein the saved state information is used by the processor to subsequently resume execution of the first task.

3. The apparatus of claim 1 wherein the decoder and encoders comprise traders of resources, and wherein the data sharing component comprises:
a first element to initiate an asynchronous trading round in response to a trader's notification that it knows that it will generate a resource;
a second element to allow other traders to advertise availability of their resources during the trading round;
a third element to allow any of the traders to remove their resource from availability;
a fourth element to allow any of the traders to select from the available resources; and
a fifth element to allow any of the traders to check if other traders have selected their resource.

4. The apparatus of claim 1 wherein the first task can call a synchronization object to inform the task scheduler that it is yielding and to instruct the task scheduler to perform the user-mode context switching.

5. The apparatus of claim 1, further comprising at least one processor, wherein the certain ones of the encoders and decoder that share common data run on a same processor.

6. The system of claim 1 wherein the common data is used by the certain ones of the encoders and decoders before that data is displaced in a cache.

7. An apparatus, comprising:
a system to execute a plurality of tasks that use data during task execution;
a data sharing component linked to the system to allow certain tasks to share some data; and
a task scheduler linked to the system to schedule tasks to be performed by the system, determined at least in part based on shared common data.

8. The apparatus of claim 7 wherein the task scheduler is further able to use user-mode context switching to allow a first task to yield execution to a second task and then allow the first task to subsequently resume execution while remaining in the user-mode.

9. The apparatus of claim 7 wherein the system comprises a transcoder unit having:
an arrangement of at least one decoder and a plurality of encoders;
a file reader to provide data to the arrangement;
a multiplexer to receive outputs from the arrangement; and
a file writer to receive an output from the multiplexer.

10. The apparatus of claim 7, further comprising a stack associated with a first task, wherein state information is saved to the stack by a processor if the first task yields to a second task and wherein the saved state information is used by the processor to subsequently resume execution of the first task.

11. The apparatus of claim 7 wherein the system comprises traders of resources, and wherein the data sharing component comprises:
a first element to initiate an asynchronous trading round in response to a trader's notification that it knows that it will generate a resource;
a second element to allow other traders to advertise availability of their resources during the trading round;
a third element to allow any of the traders to remove their resource from availability;
a fourth element to allow any of the traders to select from the available resources; and
a fifth element to allow any of the traders to check if other traders have selected their resource.

12. A method, comprising:
obtaining resources that can be used by processor-executable tasks;
scheduling a plurality of tasks based at least in part on some resources that can be shared by the tasks; and
if a first task yields its execution to a second task, performing user-mode context switching to execute the second task while remaining in user mode and without entering kernel mode.

13. The method of claim 12, further comprising sharing resources using brokers and traders that perform tasks by:
initiating an asynchronous trading round in response to a trader's notification that it knows that it will generate a resource;
allowing other traders to advertise availability of their resources during the trading round;
allowing any of the traders to remove their resource from availability;
allowing any of the traders to select from the available resources; and
allowing any of the traders to check if other traders have selected their resource.

14. The method of claim 12, further comprising:
providing a stack with the first task;
saving state information to the stack if the first task yields to the second task; and
using the saved state information to subsequently resume execution of the first task.

15. The method of claim 12, further comprising:
calling a synchronization object to indicate that the first task is yielding; and
using the synchronization object to trigger the user-mode context switching.

16. The method of claim 12, further comprising determining if the first task is a yieldable task and if so:
loading context information associated with the first task; and
executing instructions to simulate returning from yielding of execution and to resume execution where execution ended prior to yielding.

17. The method of claim 14, further comprising if the first task yields:
loading context information associated with at least the second task; and
executing the second task.

18. The method of claim 12, further comprising executing tasks that share resources on a same processor.

19. The method of claim 12, further comprising using a resource common to a plurality of tasks before that resource is displaced by another resource.

20. A system, comprising:
a means for obtaining resources that can be used by processor-executable tasks;
a means for scheduling a plurality of tasks based at least in part on some resources that can be shared by the tasks; and
a means for performing user-mode context switching to execute a second task instead of a first task while remaining in user mode and without entering kernel mode, if the first task yields its execution to the second task.

21. The system of claim 20, further comprising a means for sharing resources using brokers and traders that perform tasks, including:
a means for initiating an asynchronous trading round in response to a trader's notification that it knows that it will generate a resource;
a means for allowing other traders to advertise availability of their resources during the trading round;
a means for allowing any of the traders to remove their resource from availability;
a means for allowing any of the traders to select from the available resources; and
a means for allowing any of the traders to check if other traders have selected their resource.

22. The system of claim 20, further comprising:
a means for providing a stack with the first task;
a means for saving state information to the stack if the first task yields to the second task; and
a means for using the saved state information to subsequently resume execution of the first task.

23. The system of claim 20, further comprising:
a means for determining if the first task is a yieldable task;
a means for loading context information associated with the first task, if the first task is determined to be a yieldable task;
a means for executing instructions to simulate returning from yielding of execution and to resume execution where execution ended prior to yielding task, if the first task is determined to be a yieldable task;
a means for loading context information associated with at least the second task, if the first task yields; and
a means for executing instructions to simulate return from execution of the second task, if the second task yields.

24. The system of claim 20, further comprising a means for determining whether any particular task is a yieldable task or a non-yieldable task.

25. The system of claim 20 wherein the means for performing user-mode context switching include means for performing the first and second tasks.

26. An article of manufacture, comprising:
a machine-readable medium having instructions stored thereon to cause a processor to analyze tasks, by:
obtaining resources that can be used by processor-executable tasks;
scheduling a plurality of tasks based at least in part on some resources that can be shared by the tasks; and
performing user-mode context switching to execute a second task instead of a first task while remaining in user mode and without entering kernel mode, if the first task yields its execution to the second task.

27. The article of manufacture of claim 26 wherein the machine-readable medium further includes instructions stored thereon to cause a processor to analyze tasks, by:
sharing resources using brokers and traders that perform tasks;
initiating an asynchronous trading round in response to a trader's notification that it knows that it will generate a resource;
allowing other traders to advertise availability of their resources during the trading round;
allowing any of the traders to remove their resource from availability;
allowing any of the traders to select from the available resources; and
allowing any of the traders to check if other traders have selected their resource.

28. The article of manufacture of claim 26 wherein the machine-readable medium further includes instructions stored thereon to cause a processor to analyze tasks, by:
providing a stack with the first task;
saving state information to the stack if the first task yields to the second task; and
using the saved state information to determine where to subsequently resume execution of the first task.

29. The article of manufacture of claim 26 wherein the machine-readable medium further includes instructions stored thereon to cause a processor to analyze tasks, by:
determining if the first task is a yieldable task;
loading context information associated with the first task, if the first task is determined to be a yieldable task;
executing instructions to simulate returning from yielding of execution and to resume execution where execution ended prior to yielding task, if the first task is determined to be a yieldable task;
loading context information associated with at least the second task, if the first task yields; and
executing instructions to simulate return from execution of the second task, if the second task yields.
